(19) United States
(12) Patent Application Publication
(10) Pub. No.: US 2015/0246641 A1
(43) Pub. Date: Sep. 3, 2015

(54) GUARDRAIL SYSTEM FOR A CAB ENVIRONMENT OF A MOBILE MACHINE

(71) Applicant: Caterpillar Inc., Peoria, IL (US)

(72) Inventors: Saravanan Jayapalan, Chennai (IN); ShamShad S. Ahmed, Forsyth, IL (US)

(73) Assignee: CATERPILLAR INC., PEORIA, IL (US)

(21) Appl. No.: 14/698,900

(22) Filed: Apr. 29, 2015

(51) Int. Cl. B60R 3/00

(52) U.S. Cl. CPC B60R 3/005

(57) ABSTRACT

A guardrail system for a mobile machine's cab environment for temporarily enclosing an open access area of a walkway. The walkway includes a fixed rail portion, a rail panel assembly having a rail docking assembly and an access walkway. The rail panel assembly including at least one leg member defining an engagement portion of the at least one leg member, and a receiving portion defined by the access walkway. The rail docking assembly comprising of at least one first bracket, at least one second bracket, and a fastener. The first bracket being attachable to the fixed rail portion and the second bracket being attachable to the rail panel assembly, wherein the engagement portion of the at least one leg member being engageable with the receiving portion of the access walkway corresponding to the open access area being at least partially enclosed by the rail panel assembly, wherein the second bracket and corresponding rail panel assembly being removably attachable to the first bracket and corresponding fixed rail through the fastener.

### TECHNICAL FIELD

The present disclosure relates generally to a guardrail system for enclosing an open access walkway of a machine. In particular, a guardrail system to enclose a portion of the walkway of the machine in proximity to the operator cabin of a mobile machine.

### BACKGROUND

Off-highway machines, such as large mining trucks, are used to transfer material from one place to other. The material is carried in a load-body that can be tilted from a substantially horizontal position to an acute angle or inclined position such that the material slides out of the load-body. The inclined position is preferred during offloading of the material being carried, and the horizontal position is preferred during the storing and transfer of the material.

During the service operations of such machines the load-body may be required to be in a tilted-up position. In the tilted-up position, an operator may have access to equipment panels built into the rear portion of an operator cab to reveal components such as an aftertreatment module, fluid reservoirs or filters that require periodic maintenance. During such service operations, the load-body is securely locked in the tilted-up position, and an alarm system may also be installed to notify operator, in case the load-body is tilted up however not in the locked position.

In current machines, an operator may face challenges relative to keeping stable footing as there may be slippery portions of the walkway surrounding the cab especially at the rear of the operator cabin. This situation may be further exacerbated at the site of the rear of the cab since there exists no handrail for the operator to grasp to regain footing because such handrail would interfere with the load-body as it is returned to the horizontal position.

U. S. Pat. No. 8,801,041 B2 relates to a fluid storage container and method. The fluid storage container includes a tank for storing fluid and a working surface area walkway built into an end of the tank. There are handrails on the walkway that can be positioned depending on the required function of the tank. The fluid storage container includes a receptacle to secure leg portions of the handrails to erect the handrails when it is desired to have a handrail. A safety chain connects between handrails of adjacently parked containers. The position of handrails can be shifted from a storage configuration to an “in-place” configuration, as required and the leg portions of the handrail are slid into the associated receptacles. The receptacles are permanently attached to a perimeter of the walking area for receiving the leg portions of the handrail and once erected the handrails provide a barrier along an edge of the walkway. Additional receptacles are positioned next to a wall area of the storage container to receive the leg portions of the barriers for the purpose of storing the handrails out of the way and next to the fluid storage container when not required.

The patent '041 requires the receptacles to be permanently fixed to the portions of the walkway for receiving the handrails in both the stored and operable-barrier positions. Such constrains describes a definite stored positions of the handrails, defined by the strategic placement of the receptacles. Therefore, such designs are adaptable to commonly used structures such as fixed guardrails. The prior art fails to identify a flexible mounting location for storage of handrails and lacks strength to support wider and heavier handrails for an operator support.

### SUMMARY OF THE INVENTION

In accordance with one aspect of the present disclosure, a guardrail system for a mobile machine's cab environment is provided for temporarily enclosing an open access area of a walkway. The open access area of walkway includes a fixed rail portion, a rail panel assembly and a rail docking assembly. The fixed rail portion is firmly attached along the edges of the walkway, wherever required at predefined locations. The rail panel assembly including at least one leg member defining an engagement portion of the at least one leg member, and a receiving portion defined by the access walkway assembly. The rail docking assembly comprising at least one first bracket, at least one second bracket, and a fastener. In one aspect of the invention, the first bracket is attached to the fixed rail portion and the second bracket is attached to the rail panel assembly, wherein the engagement portion of the at least one leg member of the rail panel assembly is engaged with the receiving portion of the access walkway assembly corresponding to the open access area, that is being at least partially enclosed by the rail panel assembly. In another aspect of the invention, the second bracket and corresponding rail panel assembly is removably attached to the first bracket and corresponding fixed rail, through the fastener. Thus, the rail panel assembly can be removably attached to the open access area of walkway or at any location to the fixed rail portion.

### BRIEF DESCRIPTION OF THE DRAWINGS

FIG. 1 is a perspective view of a mobile machine illustrating a raised load-body with rail panel assemblies in a stored position along fixed rail portions of the machine according to the concepts of the present disclosure;

FIG. 2 is a perspective view of the front portion of the machine of FIG. 1 with all other aspects of the machine removed to illustrate the rail panel assembly of the guardrail system being removably coupled to the fixed rail portion of the machine through a rail docking assembly, according to the concepts of the present disclosure;

FIG. 3 is an exploded view of the guardrail system of FIG. 2, illustrating the assembly of the rail panel assemblies in a stored position, according to one aspect of the disclosure;

FIG. 4 is a perspective view of the guardrail assembly in association with a rear portion of the cab shown in FIG. 2, with the rail panel assemblies deployed to form a closed enclosure for the access walkway according to an aspect of the present disclosure;

FIG. 5 is a perspective view of the guardrail system of FIG. 2, with the rail panel assemblies deployed and the cab removed to illustrate the guardrail system enclosing an access area of a walkway of the machine, according to concepts of the present disclosure; and

FIG. 6 is an enlarged, exploded view of the encircled portion of FIG. 3, illustrating the rail docking assembly, according to an embodiment of the present disclosure.

FIG. 7 is an enlarged, exploded view of the encircled portion of FIG. 4, illustrating the engagement of leg member into receptacles, according to an embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

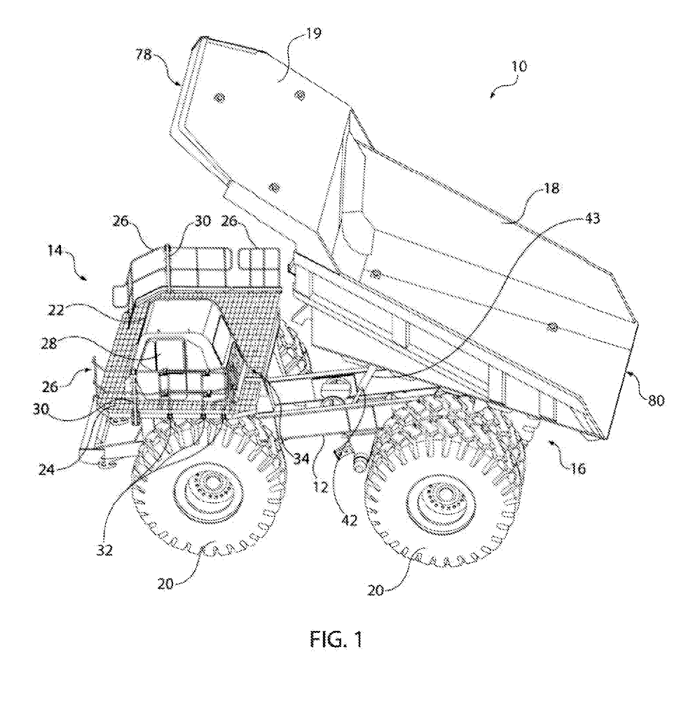

FIG. 1 illustrates an exemplary mobile machine 10. In the illustrated embodiment, the mobile machine 10 is an off-highway truck. However, the present disclosure may be embodied in any type of machine having unenclosed portions of access walkway, for example, large mining trucks, off-road haul trucks, excavators, track loaders, and the like. The mobile machine 10 may be interchangeably called as machine, in the rest of the description. In accordance with the concepts of this disclosure, the mobile machine 10 includes a frame 12, a front portion of the machine 14, a rear portion of the machine 16, a load-body 18 having a front side 78 and a rear side 80, wheels 20, and an operator station 22. The mobile machine 10 may be operated by receiving power from an internal combustion engine (not shown) or by any other known methods in the art such as an electrical generator, assembled to the frame 12 of the machine 10. In the current embodiment, the frame 12 is assembled substantially parallel to ground, supported on wheels 20 via wheel axles (not shown).

The rear portion 16 of the machine 10 includes the load-body 18 pivotally connected to the frame 12. The load-body 18 is used for carrying material and dump the material by raising the load-body 18 generally away from the machine's frame 12 as is customary. The movement of load-body 18 during a typical dump cycle is actuated by a hoist assembly 42 located between the front and rear wheel axles (not shown). The hoist assembly 42 includes a hydraulic cylinder 43 however it may be powered by electrical or mechanical means as well as through hydraulic activation. The hoist assembly 42 includes two ends (not shown), one end is fixed to the frame 12 and the other end may be attached to the bottom side of the load-body 18. The fully extended hoist assembly 42 coincides with the load-body 18 being fully raised from a load carrying mode i.e. typically parallel to the ground, to a load dumping mode i.e. the front portion of the load-body 18 at a higher potential with respect to the rear portion of the load-body 18. Although, a hydraulic cylinder type hoist assembly 42 is disclosed in the current embodiment, any other type of load-body lifting mechanism may be employed, as known in the art.

The load-body 18 may include a canopy portion 19 on the front side 78 of the load-body 18, to provide protection to the operator station 22 from foreign objects that may be deflected from the operator station 22 during operation of the machine 10. In the load carrying mode, the position of the canopy portion 19 and portions of the load-body 18 are within proximity to the operator station 22.

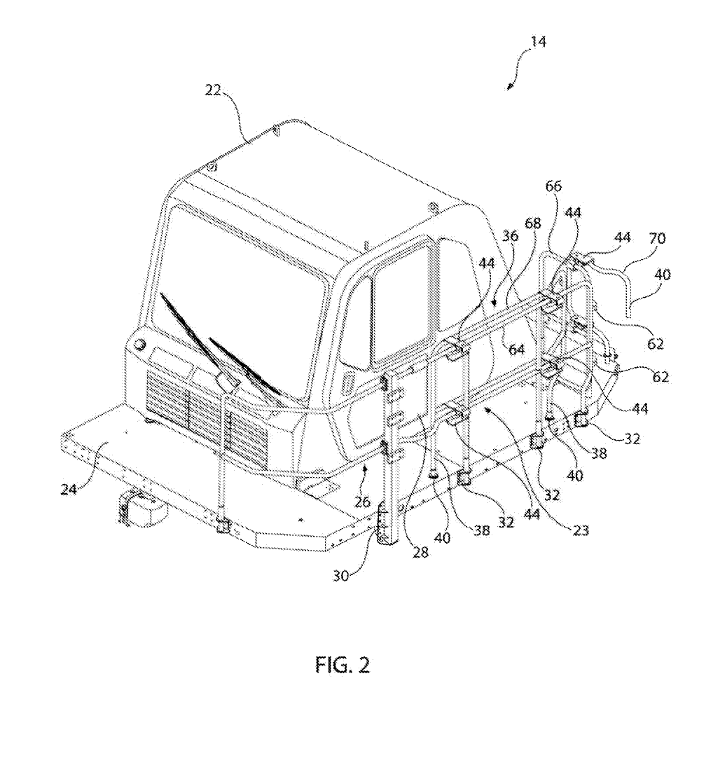

As illustrated in FIG. 2, a guardrail system 23 is shown in proximity to the front portion of the machine 14 and includes an access walkway assembly 24 enclosed by a fixed rail portion 26. The access walkway assembly 24 is typically designed to surround a generally horizontally positioned deck area around the operator station 22 to provide access for the operator or service personnel to access the operator station for servicing or maintenance, for example. The access walkway assembly 24 thus formed, not only provides access to a door 28 of the operator station 22 but also provides access to servicing/maintenance of components, such as windshield, rear window, side window, electrical/electronic components, etc.

The fixed rail portion 26 extend upwards from the access walkway assembly 24 in a vertical direction. The fixed rail portion 26 is typically provided on the front and side portions of the access walkway assembly 24 and not provided in the rear side of the operator station 22, due to the interference of the load-body 18 with the operator station 22 in the load carrying mode. This creates an open access area 34. The fixed rail portion 26 may be a single continuous assembly or an assembly of multiple fixed rail portions, attached to each other. In the current embodiment, two fixed rail portions 64 and 66 are assembled to the access walkway assembly 24 near the front left side of the mobile machine 10. The two fixed rail portions 64 and 66 are attached to each other by hinge members 62. The fixed rail portions 64 and 66 are structurally supported using pillars 30 and fixtures 32.

The fixed rail portions 64 and 66 include fixed guardrails 27 and the fixed guardrails 27 may be manufactured from steel bars, tubes or channels and be welded or bolted together as is customary. The fixed guardrails 27 are assembled with the fixed rail portions 64, 66, to provide strength to the rail however the rail must not obstruct the view of an operator seated in the operator station 22. The hinge members 62 may be a simple bolt and nut joint or a pint joint or any other hinge assemblies know to those with ordinary skill in the art.

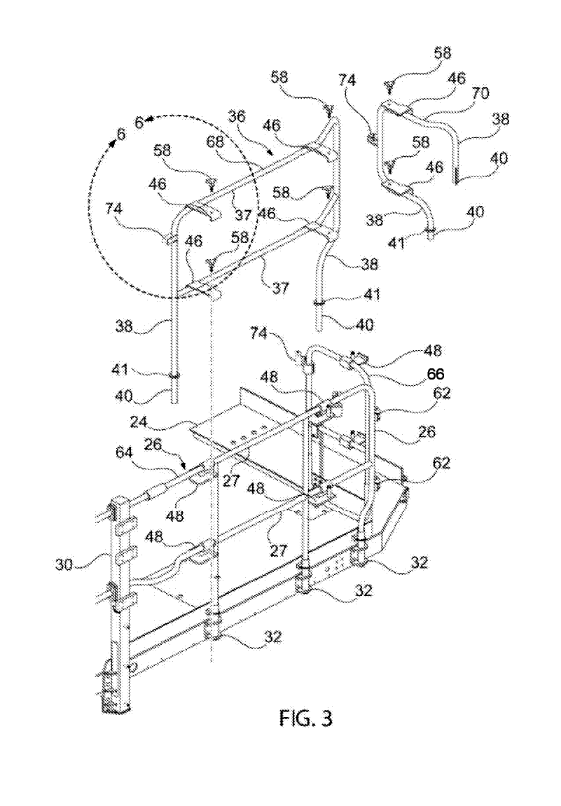

As illustrated in FIG. 2, in an embodiment, a rail panel assembly 36 including portable rail panels 37 (shown in FIG. 3) and leg members 38 are removably attached to the fixed rail portions 64, 66 via rail docking assemblies 44. In an exemplary embodiment, the rail panel assembly 36 may be made up of a unitary assembly or it is envisioned that an assembly of multiple rail panels, may be assembled to result in a unitary assembly. In the current embodiment, two rail panel assemblies 68 and 70 are removably connected or “docked” with the fixed rail portions 64 and 66, respectively so as to allow an operator expedient access to such removable panels in preparation for assembling the same in a fixed positioned as will be hereinafter explained.

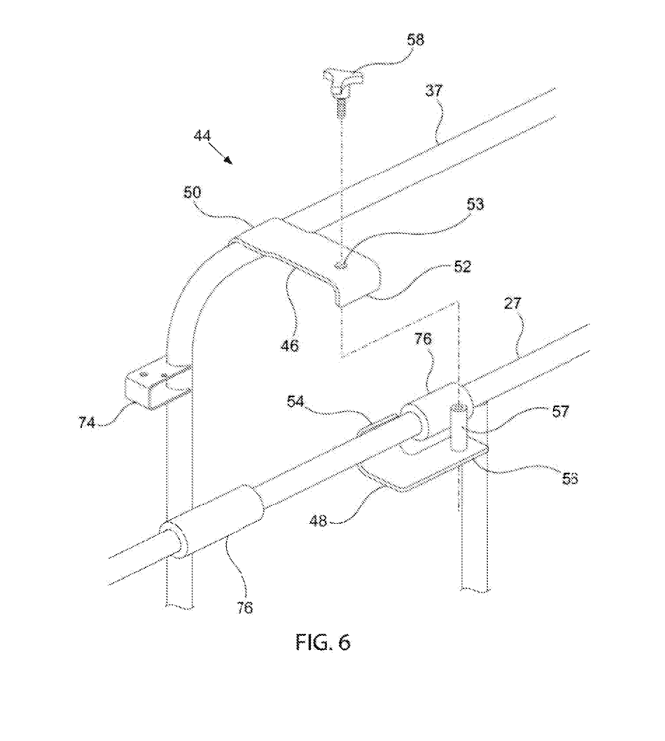

As shown in FIG. 3, each rail docking assembly 44 includes a first bracket 46 located on the portable rail panel 37 and a second bracket 48 located on the fixed guardrails 27. In an embodiment, details of the first bracket 46 and the second bracket 48 are illustrated in FIG. 6 and described hereon. The first bracket 46 includes a first end 50 and a second end 52. The first end 50 of the first bracket 46 is integrally attached to each of the portable guardrails 37 of the rail panel assemblies 68 and 70. The second end 52 of the first bracket 46 includes a fastener guiding feature 53, such as a through hole, for example. The second bracket 48 includes a first end 54 and a second end 56. The first end 54 of the second bracket 48 is integrally attached to the fixed guardrail 27 of the fixed rail portions 64 and 66. The second end 56 of the second bracket 48 includes a fastener securing feature 57, such as a threaded hole, threaded boss, weld-nut etc. In illustrated embodiment, the fastener securing feature 57 is a threaded boss, being integrally attached to the second end 56 of the second bracket 48. The integral attachment of first bracket 46 with the rail panel assemblies 68, 70 and the second bracket 48 with the fixed rail portions 64, 66, may be achieved by welding, for example. A fastener 58 is used to couple the first bracket 46 and second bracket 48.

In an exemplary embodiment, the first bracket 46 along with the fastener guiding feature 53 of the second end 52 is attached to each portable guardrail 37 of the rail panel assemblies 68, 70 and the second bracket 48 along with the fastener securing feature 57 of the second end 56 is attached to the fixed guardrail 27 of the fixed rail portions 64, 66, is illustrated. In another embodiment, it may be contemplated that the first bracket 46 may have the fastener securing feature and the second bracket 48 may have the fastener guiding feature. It is also envisioned that the fastener securing feature 57 is a unitary feature of the second end 56, such as internal threads, for example.

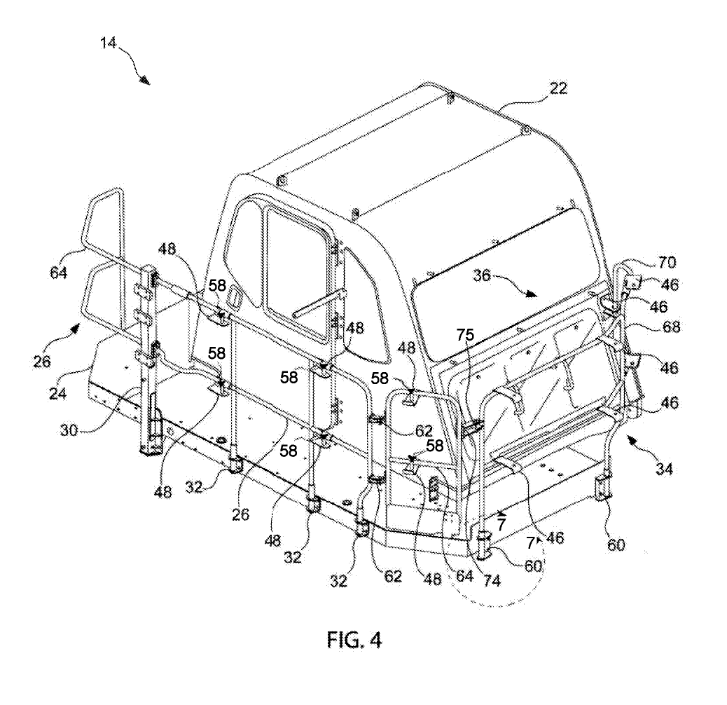

The current disclosure contemplates that other rail docking assembly constructions may be possible. For example, the first bracket 46 may be integrally attached to each portable guardrail 37 of the rail panel assemblies 36, while the second bracket 48 may be free to slide and rotate along the centerline of the fixed guardrails 27 of the fixed rail portion 26 or vice-versa. As illustrated in FIG. 4, in one embodiment, the rail panel assemblies 68, 70 are shown undocked and positioned to enclose a rear portion of the access walkway assembly 24 in proximity to the rear of the operator station 22 corresponding to the truck body being raised. In this embodiment, the rail panel assemblies 68, 70 are detached from the fixed rail portions 64, 66 respectively, by unfastening the fasteners 58. The detached rail panel assemblies 68, 70 are assembled in the open access area 34, by coupling an engagement portion 40 of the leg members 38 to receptacles 61 placed within receiving portions 60 of the access walkway assembly 24. The receptacles 61 are designed such that that the engagement portion 40 of the leg members 38 slid into apertures 86 of the receptacle 61 and provide enough support to the entire rail panel assemblies.

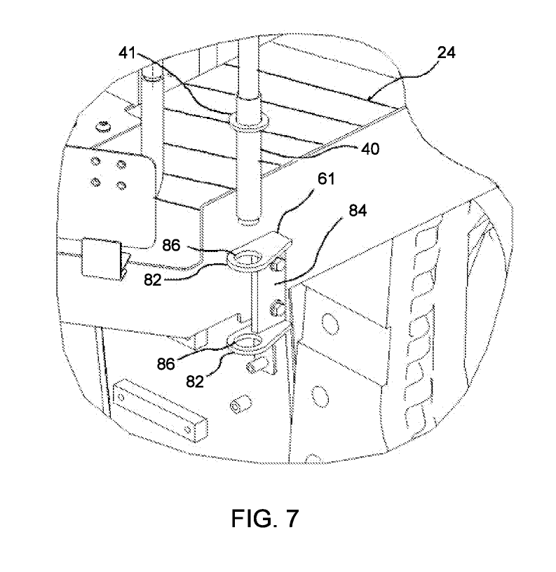

Referring to FIG. 7, the receptacle 61 has a long c-shaped member that has apertures 86 on flange portions 82 and web portion 84 of the receptacle being attached to the access walkway assembly 24. In an embodiment, the web portion 84 of the receptacles 61 may be bolted or welded to the sides of the walkway assembly 24. The size of the apertures being slightly larger than the circumferential geometry of the leg members 38, to provide easy assembly and disassembly. Also, the distance between the two flange portions 82 of the c-shaped receptacle 61 being sufficiently large enough, that it supports any lateral load applied on the rail panel assemblies 67, 70. The leg members 38 have a tab portion 41 larger than the size of the aperture of the c-shaped member near the engagement portion 40, so that when the tab portion 41 hit against the flange portion 82 of the receptacle 61, the movement of leg member 38 is restricted. Thus, the rail panel assembly 36 may be coupled to the walkway assembly 24. In an exemplary embodiment, the receiving portions 60 of the access walkway assembly 24 are placed such that the rail panel assembly 36 can be assembled at the desired location. In an exemplary embodiment, the fasteners 58 are captive type fasteners that always remain attached to the first bracket 46. In another embodiment, while the rail panel assembly 36 is detached with the fixed rail portion 26, the fasteners 58 may be stored by fastening them to the corresponding fastener securing portions 57 of the first bracket 46.

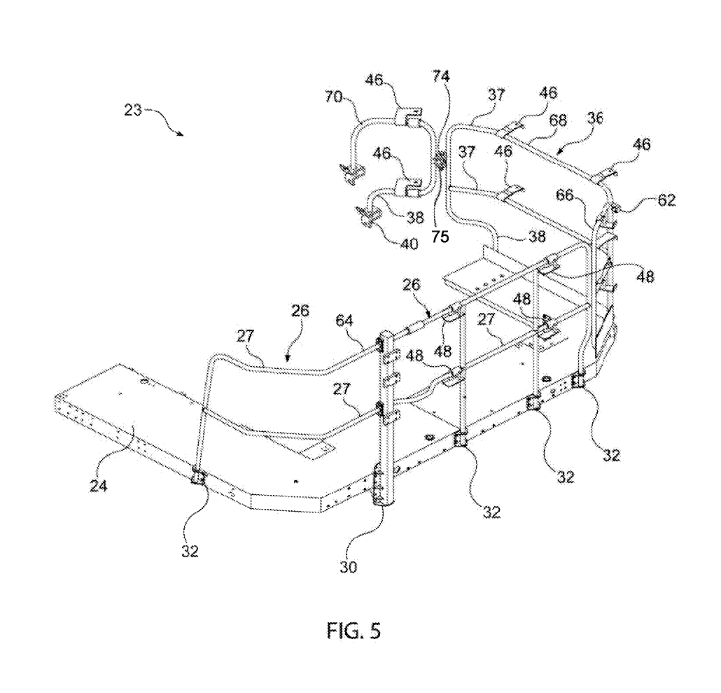

Referring to FIG. 5, the first rail panel assembly 68 is assembled to the receiving portion 60 of the walkway access 60 and supported by the second fixed rail portion via the support members 74. The second rail panel assembly 70 is assembled to the walkway assembly 24, supported by the first rail panel assembly 68, and the rear side of the operator station 22 via support members 74. Each support member 74 may be a u-shaped members welded to rail 27, 37 which engages a dual bar interlocking member 75 with a lock pin extending through a hole aligned through the u-shaped member and the dual bar interlocking member 75, for example. In other embodiments, the support members 74 may be of any other known methods to quickly connect and disconnect the rail panel assembly 36 with the fixed rail portions 26. The fixed rail portions 64, 66 and the rail panel assemblies 68, 70 are attached in an in-line fashion, as explained before, to provide complete protection for an operator over the access walkway assembly 24. In an embodiment, rail panel assemblies 68 and 70 of different size and shapes may be used to enclose the open access area 34.

As illustrated in FIG. 6, the latching of rail docking assembly 44 to store the rail panel assembly 36 with the fixed rail portion 26 is shown. The fixed guardrails 27 of the fixed rail portion 26 or the portable guardrail 37 of the rail panel assembly 36 are covered with bumpers 76. Each bumper 76 may be made of an elastomeric or plastic material and be assembled in between the first bracket 46 and the second bracket 48 of the rail docking assembly 44 to avoid the wear and tear of the rail panel assemblies being docked to the fixed rail assemblies 64, 66. These bumpers 76 improve the life of the rails 27, 37, due to frequent coupling/de-coupling of the rail panel assembly 36 with the fixed rail portion 26. These bumpers may also be placed at other locations over the rails 27 of the rail panel assembly 36 to avoid cabin door being hit to the rails 27, to provide additional grip and ergonomics to an operator. In an embodiment, these bumpers 76 may be attached by gluing them onto the guardrails 27 with the help of an adhesive, as ordinarily known in the art.

### INDUSTRIAL APPLICABILITY

The industrial applicability of a guardrail system 23 of a mobile machine 10 described herein will be readily appreciated from the foregoing discussion. As described earlier the mobile machine 10 includes, a load-body 18 attached to the frame 12 of the machine 10.

When the load-body 18 is in elevated and locked in an up position, the operator may have access to the rear portion of the access walkway assembly 24 for servicing or maintenance operations. In such situations, the walkway in proximity to the rear side of the operator station 22, does not have a railing which may increase the risk of instability for the operator intending to traverse this part of the walkway. Moreover, the operator may desire to use safety harnesses when traversing this portion of the walkway since there lacks a guardrail however with the rail panels in place the operator may not require the safety harness as may be suggested in the operator's manual of the machine. Therefore, an enclosure for such open access area 34 is provided and may be removably mounted and also easily and conveniently stored.

At the rear portion of the operator station 22, several machine subsytems may be housed within compartments in the base of the operator station 22 such as the various fluid levels, filters, fuses, engine control module (ECM), wiring harness, switches, etc. An operator may be required to inspect these component during service or maintenance operations. Once the load-body 18 is raised and locked in the up position access to the walkway surrounding the rear portion of the cab is exposed to provide access for an operator to the open access area 34. During maintenance to subsystems and components at the rear of the cab, the operator seeks to traverse the walkway however may require a safety harness to ensure he remains safe where there is not a rail. However, the use of the safety harness may be lessened or used, if at all, in compliance with practices suggested and established by the manufacturer. However, as is disclosed in the present disclosure the rail panels when erected provide a rail for the operator to stabilize himself when accessing the area of the walkway at the rear portion of the operator cab. This need for this additional guardrail may be even more critical in severe climates for example for use with machines operating in cold climate regions, wherein the access walkway assembly 24 may be slippery due to snow, ice, or sleet. Thus a portable rail support is provded at the perimeter of the open access area 34 at the rear portion of the cab's walkway, and a portable rail assembly that can be quickly assembled and disassembled during servicing and maintenance operations. The guardrail system 23 has been designed to solve this problem that will be explained hereinafter.

The guardrail system 23 for the mobile machine 10 in the vicinity of the cab or operator station 22 includes the fixed rail portion 26 extending from the access walkway assembly 24, a rail panel assembly 36, and a rail docking assembly 44 that can quickly couple or decouple the rail panel assembly 36 to the fixed rail portion 26. The rail panel assembly 36, in an exemplary embodiment, may be one single unit made of integrating several pieces of tubes or channels. The rail panel assembly 36 includes leg members 38 having engagement portions 40 which are selectively engaged or “slid into” female receiving portions or features 60 secured to the walkway assembly 24.

In one aspect of the disclosure, a first configuration or stored configuration is described wherein the rail panel is assembled 36 to the fixed rail portion 26 via the rail docking assembly 44. A first bracket 46 attached to the rail panel assembly 36 is connected to the second bracket 48 attached to the fixed rail portion 26 via fasteners 58. In a second configuration or erected configuration the rail panel assembly 36 is decoupled with the fixed rail portion 26 and attached to the access walkway assembly 24 along the perimeter of the walkway near the rear portion of the cab. The steps involved in switching from the first configuration to the second configuration is described below.

As illustrated in FIG. 1, the load-body 18 is raised and locked in the elevated position. The operator unlocks the second fixed rail portion 66 with the access walkway 24 and rotates the second fixed rail portion 66 about the axis of the hinges 62 to about 45 degrees, to align it about the external contour of walkway access 24. The operator then locks the position of the second fixed rail portion 66 to the access walkway 24. The first rail panel assembly 68 is decoupled with the first fixed rail portions 64, by unfastening fasteners 58, and then the rail panel assembly 68 may be lifted and placed at the rear side of the operator station 22, such that the engagement portion 40 of the leg member 38 of the first rail panel assembly 68 is seated in receptacle member 61 of the receiving portions 60 of the access walkway assembly 24, as shown in FIG. 4. The rail panel assembly 68 would be locked into position, as the leg members 38 are slid into the flange portions 82 of the c-shaped receptacle 61, until the tab member on the leg member 38 butt against the flange of the receptacle 61. In the locked position, the engagement portion 40 of the leg member is secured within the flanges of the c-shaped receptacle 61. The operator then removes the fasteners 58 to decouple the second rail panel assembly 70 from the second fixed rail portion 66. The second rail panel assembly 70 may be lifted manually and placed at the rear side of the operator station 22, such that the engagement portion 40 of the leg member 38 of the second rail panel assembly 70 is seated in receptacle member 61 of the receiving portions 60 of the walkway assembly 24. Referring to FIG. 4, the fasteners 58 are coupled to the second bracket 48 of the first fixed rail portion 26, such that the fasteners are stored. Then the operator unfastens the fasteners 58 that decouples the second rail panel assembly 70 to the second fixed rail portion 68, lifts the second rail panel assembly 70 and places it in the rear side of the operator station 22, such that the engagement portion 40 of the leg member 38 of the second rail panel assembly 70 is seated in receiving portions 60 of the access walkway assembly 24. The fasteners 58 are coupled to the second bracket 48 of second fixed rail portion 70, such that the fasteners are stored. The support members 74 along with the dual bar members 75 assist in interconnecting the second rail panel assembly 70 to the first rail panel assembly 68, and the first rail panel assembly 68 with the second fixed rail portion 66.

To change from the second or erected configuration back to the stored or first configuration of the guardrail system 23, the steps explained above should be performed in the reverse order. This gives a great flexibility to an operator to quickly couple and decouple the rail panel assemblies with the fixed rail portions using the specially designed rail docking assembly 44. The rail docking assembly 44 described here can be used with

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A guardrail system for a mobile machine cab environment for enclosing a perimeter portion of an open access area of a walkway, the walkway including a fixed rail portion and an access walkway, the guardrail system comprising;
a rail panel assembly including at least one leg member defining an engagement portion of the at least one leg member, and a receiving portion defined by the access walkway; and
a rail docking assembly comprising: at least one first bracket and at least one second bracket, and a fastener, the first bracket being attachable to the fixed rail portion and the second bracket being attachable to the rail panel assembly,
wherein the engagement portion of the at least one leg member being engageable with the receiving portion of the access walkway corresponding to the open access area being at least partially enclosed by the rail panel assembly, wherein the second bracket and corresponding rail panel assembly being removably attachable to the first bracket and corresponding fixed rail portion through the fastener.
